(19) United States
(12) Patent Application Publication
(10) Pub. No.: US 2021/0133610 A1
(43) Pub. Date: May 6, 2021

(54) LEARNING MODEL AGNOSTIC MULTILEVEL EXPLANATIONS

(71) Applicant: International Business Machines Corporation, Armonk, NY (US)

(72) Inventors: Karthikeyan Natesan Ramamurthy, Pleasantville, NY (US); Bhanukiran VINZAMURI, Elmsford, NY (US); Amit DHURANDHAR, Yorktown Heights, NY (US)

(21) Appl. No.: 16/668,267

(22) Filed: Oct. 30, 2019

(51) Int. Cl. G06N 5/04; G06N 20/00; G06N 5/00

(52) U.S. Cl. CPC G06N 5/045; G06N 5/003; G06N 20/00

(57) ABSTRACT

A method, system and apparatus of using a computing device to explain one or more predictions of a machine learning model including receiving by a computing device a pre-trained artificial intelligence model with one or more predictions, generating by the computing device a multilevel explanation tree, linking neighborhood of datapoints around each of a plurality of training datapoints to the one or more predictions, and utilizing by the computing device the multilevel explanation tree to explain one or more predictions of the machine learning model.

### BACKGROUND OF THE INVENTION

### Field of the Invention

The disclosed invention relates generally to an embodiment of a method and system for a learning model, and more particularly, but not by way of limitation, relating to a method, apparatus, and system for learning model agnostic multilevel explanations.

### Description of the Background Art

Blackbox explainability is of the utmost importance in today's world which is stemming from several concerns on interpretability, ethics and bias in AI (artificial intelligence). Given the ready availability of pre-trained models with state-of-the-art performances, and their ubiquitous adoption by researchers and practitioners, post-hoc explanations of model predictions is valuable.

Explaining the predictions of black box models has several uses such as interpretation of predictions for the user, understanding the behavior of the model with respect to various inputs, and probing/debugging of such models. Black box explainability is an extremely active area given the wide spread use of opaque classifiers such as deep neural networks in various domains.

As a result, there has been a surge of interest in developing explainable AI (XAI) techniques. Local explanations do not provide insights into how well they will generalize to unseen instances. They can also be excessively complex for a user who wants to understand the overall behavior of the model. Global explanations reveal the overall model behavior but fail to capture certain subtle characteristics of local explanations.

Learning a natural multi-level hierarchy of explanations from local to global in a unified approach can provide a complete perspective on the explanation space. Current settings generate hierarchical explanations via a two-step approach, LIME (Local Interpretable Model Explanations methods, or other similar techniques that had a plurality of deficiencies including a lack of principled joint optimization techniques for learning multilevel explanation trees.

Therefore, there is a need to provide a device, system and a method of obtaining consistent, multilevel explanations for a group of examples (viz. the training set).

### SUMMARY OF INVENTION

In view of the foregoing and other problems, disadvantages, and drawbacks of the aforementioned background art, an exemplary aspect of the disclosed invention provides a method, apparatus, and system for learning model agnostic multilevel explanations.

One aspect of the present invention is to provide a method of using a computing device to explain one or more predictions of a machine learning model, the method including receiving by a computing device a pre-trained artificial intelligence model with one or more predictions, generating by the computing device a multilevel explanation tree, linking neighborhood of datapoints around each of a plurality of training datapoints to the one or more predictions, and utilizing by the computing device the multilevel explanation tree to explain one or more predictions of the machine learning model.

Another aspect of the present invention provides a system for explaining one or more predictions of a machine learning model, including a computer, including a memory storing computer instructions, and a processor configured to execute the computer instructions to receive a pre-trained artificial intelligence model with one or more predictions, generate a multilevel explanation tree, linking neighborhood of datapoints around each of a plurality of training datapoints to the one or more predictions, and utilize the multilevel explanation tree to explain one or more predictions of the machine learning model.

Another example aspect of the disclosed invention is to provide a computer program product comprising a computer readable storage medium having program instructions embodied therewith, the program instructions readable and executable by a computer to cause the computer to perform a method, including receive a pre-trained artificial intelligence model with one or more predictions, generate a multilevel explanation tree, linking neighborhood of datapoints around each of a plurality of training datapoints to the one or more predictions, and utilize the multilevel explanation tree to explain one or more predictions of the machine learning model.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

It is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF DRAWINGS

The exemplary aspects of the invention will be better understood from the following detailed description of the exemplary embodiments of the invention with reference to the drawings.

FIG. 1 illustrates an example decision tree of an example embodiment.

FIG. 2 illustrates the mathematical formulation in an example embodiment.

FIG. 3 illustrates the optimization in MAME in an example embodiment.

FIG. 4 illustrates the method for system in an example embodiment.

FIG. 5 illustrates the method for the system in an example embodiment.

FIG. 6 illustrates the application results for automgs.

FIG. 7 illustrates the application results for communities.

FIG. 8 illustrates the application results for happiness.

FIG. 9 illustrates the application results for music.

FIG. 10 illustrates the application results for day.

FIG. 11 illustrates the application results for Oil & Gas.

FIG. 12 illustrates the comparison of the MAME system and the step method.

FIG. 13 illustrates Two Step transition across levels for a sample instance.

FIG. 14 illustrates the MAME explanation transition across levels for a sample instance.

FIG. 15 illustrates the 5 representative explanations for a given level for Reservoir tree.

FIG. 16 illustrates an example implementation.

FIG. 17 illustrates an exemplary hardware/information handling system for incorporating the example embodiment of the invention therein.

FIG. 18 illustrates a signal-bearing storage medium for storing machine-readable instructions of a program that implements the method according to the example embodiment of the invention.

FIG. 19 depicts a cloud computing node according to an example embodiment of the present invention.

FIG. 20 depicts a cloud computing environment according to an example embodiment of the present invention.

FIG. 21 depicts abstraction model layers according to an example embodiment of the present invention.

### DETAILED DESCRIPTION OF PREFERRED EMBODIMENTS

The invention will now be described with reference to the drawing figures, in which like reference numerals refer to like parts throughout. It is emphasized that, according to common practice, the various features of the drawing are not necessarily to scale. On the contrary, the dimensions of the various features can be arbitrarily expanded or reduced for clarity. Exemplary embodiments are provided below for illustration purposes and do not limit the claims.

As mentioned, black box explainability is an extremely active research area given the wide spread use of opaque classifiers such as deep neural networks in various domains. Although post-hoc local explainability has received a lot of attention there has been much less work on using these methods to obtain consistent, multilevel explanations for a group of examples (viz. the training set).

The system and method shown accomplish precisely this, where given a linear or non-linear local explainability technique such as LIME we propose a (meta-) method that can build multilevel explanations with monotonically increasing and (explicitly) controllable cohesion from the leaves to the root of the constructed tree. Such a multilevel structure is a natural form of (effective) communication and hence easy to consume. The present method and system are flexible and can also take into account side information such as which examples should exhibit similar behavior. Moreover, for large enough datasets our multilevel explanation tree could serve as an efficient way of providing feature based as well as exemplar based (local) explanations for unseen test examples by associating them with the closest example in our tree. This can also have huge cost savings in practice, as each query to the black box model (e.g. deployed on someone else's cloud) may have a cost and we would now save on hundreds to thousands of these queries. The system and method can validate many such claims in the experiments where the inventors conducted a case study with human experts in the Oil & Gas industry for an uninterpretable state-of-the-art pump failure model. The inventors also experiment on 5 public datasets and showcase the power of our method in generating high fidelity and sparse explanations that change smoothly from level to level making them easy for a human to consume.

A very natural and effective form of communication is to first set the stage through high level general concepts and then only dive into more of the specifics. In addition, the transition from high level concepts to more and more specific explanations should ideally be as logical or smooth as possible. For example, when you call a service provider there is usually an automated message trying categorize the problem at a high level followed by more specific questions until eventually if the issue isn't resolved you might be connected to a human representative who can further delve into details from that point on.

Another example is when you are presenting a topic one usually starts at a high level providing some background and motivation followed by more specifics. A third example is when you visit the doctor with an ailment, you first have to fill forms which capture information at various (higher) levels of granularity such as your families medical history followed by your personal medical history, after which a nurse may take your vitals and ask questions pertaining to your current situation.

A doctor may then inquire further and check you (viz. breathing, X-rays, etc.) so as to pinpoint the problem. In all these cases, information or explanations you provide at multiple levels enables others to obtain insight that otherwise may be opaque.

Given the omnipresence of multilevel explanations across various real world settings, the present system and method proposes a novel model agnostic multilevel explanation (MAME) method that can take a local explainability technique such as LIME (Local Interpretable Model Explanations) along with a dataset and can generate multiple explanations for each of the examples corresponding to different degrees of cohesion (i.e. parameter tying) between (explanations of) the examples, where each such degree determines a level in our multilevel explanation tree and is explicitly controllable. At the extremes, the leaves would correspond to independent local explanations as would be the case using standard local explainability techniques (viz. LIME), while the root of the tree would correspond to practically a single explanation given the high degree of cohesion between all the explanations at this level.

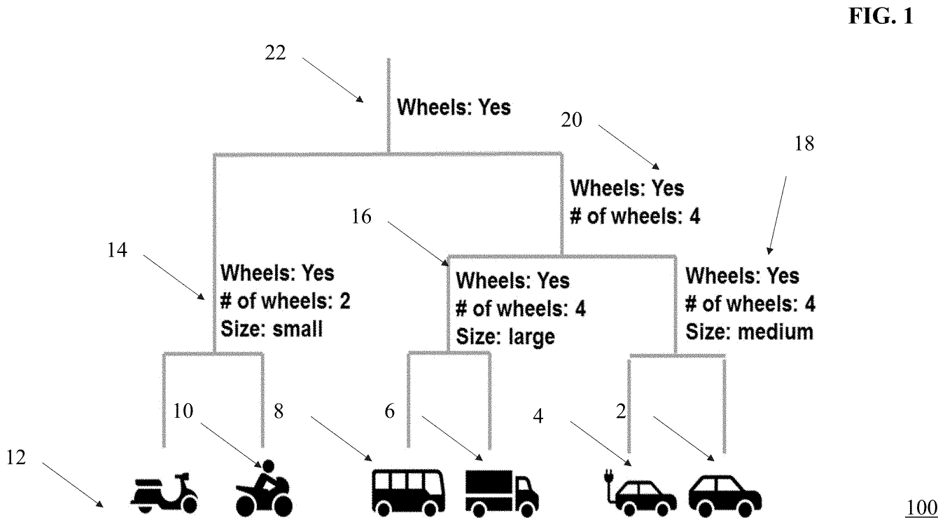

FIG. 1 illustrates an example decision tree of an example embodiment. An illustration of this is seen in FIG. 1, where the leaves constitute different kind of vehicles such as a regular car 2, an electric car 4, a truck 6, a bus 8, a bike 10 and a scooter 12. The local explanations at this level could be detailed. However, one level higher we see that only features that are common or similar are likely to be highlighted. This trend continues till the root of the tree. Such explanations can thus be very insightful in identifying key characteristics that bind together different examples at various levels of granularity. Moreover, they can also provide exemplar-based explanations looking at the groupings at specific levels (viz. a bike is more similar to a scooter than a car). For example, at the root, there is a question of whether there are wheels 22, which includes all. Then, at the next level there is a question of whether the number of wheels is four at node 20 or two at node 14. Then for the question of the wheels being four, there is a further question of the size of the wheel being large at node 16 or size being medium at node 18 and wheel size being small at node 14, which then provides the answers to the queries of a regular car 2, an electric car 4, a truck 6, a bus 8, a bike 10 and a scooter 12.

Above we see an illustration of the type of multilevel explanations the present system could generate. Each of the leaf nodes, i.e. the six vehicles would have their own explanations (not shown). One level higher the cars would be grouped as having 4 wheels and being of medium/intermediate size. Two levels higher the bus, truck and cars would be grouped as having 4 wheels and then at the root all vehicles would be categorized as having wheels. If the black box model was classifying vehicles by type i.e. cars, trucks and buses, scooters and bikes, then one level above the leaves would probably constitute the best explanations. Although the entire tree from top to bottom presents a nice gradation of what the essential component of any vehicle is (wheels) to what the different vehicles are.

As such, the present method can also take into account side information such as similarity in explanations based on class labels or user specified groupings based on domain knowledge for a subset of examples. Moreover, one can also use non-linear additive models going beyond LIME to generate local explanations. Therefore, linear or non-linear models can be used. The present method thus provides a high degree of flexibility in building multilevel explanations that can be customized apropos a specific application.

Another benefit of the present approach is that the system can efficiently provide multilevel local explanations in an online setting by finding the closest example in our dataset and then providing a hierarchy of explanations using our multilevel tree. This eliminates the need for querying the black box model hundreds to thousands of times during run time, which can also lead to significant cost savings if the model is deployed on a different institutions cloud. In fact if one just desires a local explanation, a priori the present system can find the level in our tree that has the best generalization performance and report the important features in that level for the closest example in our dataset to the test example. As described below, evidence can be seen from example experiments where intermediate levels seem to have the best generalization performance corresponding to a “sweet spot” given the bias variance trade-off.

For linear local models that the present system in this work, the present algorithm converges to a unique global solution. We prove that our method actually forms a tree in that examples merged in a particular level of the tree remain together at higher levels (non-expansive map).

The following are work regarding interpretable or explainable AI (artificial intelligence) and the problems set from the present methods. The most traditional direction is to directly build interpretable models such as rule lists or decision sets on the original data itself so that no posthoc interpretability methods are required to uncover the logic behind the proposed actions. These methods however, may not readily give the best performance in many applications compared with a complex black box model. In such cases, one could try to boost the interpretable models using the black box model based on various target modification and/or data augmentation or weighting techniques. In some cases though this also may be insufficient as the interpretable model may be well below par of the black box model. In such cases, using local posthoc explanations may be the best bet. These however, suffer from the limitation that the user does not have a global view of how decisions are made and the local explanations which are typically generated independently may not be consistent for nearby examples making the process of understanding and eventually trusting the underlying model extremely hard.

There are works which try to provide local as well as global explanations that are both feature and exemplar based. Exemplar based explanations essentially identify few examples that are representative of a larger set of examples, i.e. large dataset, that one wants to understand. This previous work however, uses distinct models to provide the local and global explanations where again consistency between the models could potentially be an issue. Moreover, the global (proxy) model is fixed to be a random forest which may not perform well in all cases, not to mention having 100s of trees can be challenging to directly interpret. As such, the method can also be rigid in the sense that the splits are determined by the random forest algorithm and the user has limited control over factors (e.g. enforcing custom groupings) affecting these splits, which might limit the insights he may wish to obtain. Another direction is to try to generate rationales/explanations from input text, which is relevant to natural language processing and computer vision domains. There is also an interesting line of work that tries to formalize interpretability.

One of the motivation behind the approach of the present system has relations to convex clustering, and its generalizations to multi-task learning. However, it is different in the following example ways: (1) the present application is completely different, and novel in creating multilevel explanations for black box models, whereas the prior works are geared towards clustering and multi-task learning, (2) in the instantiation presented here, local models that mimic the black box predictions are constructed using neighbors around each point that needs to be explained, whereas such constructions are not required for multi-task learning.

The present system and method propose a meta-method that can build multilevel explanations using base explanations from a local explanation model with monotonically increasing and explicitly controllable cohesion from the leaves to the root of the constructed tree.

The present Model-agnostic Multilevel explanations method (MAME) can take a local explainability technique such as LIME along with a dataset and can generate multiple explanations for each of the examples corresponding to different degrees of cohesion between (explanations of) the examples, where each such degree determines a level in our multilevel explanation tree and is explicitly controllable.

MAME can also take into account side information such as similarity in explanations based on class labels or user specified groupings based on domain knowledge for a subset of examples. MAME is agnostic to the blackbox model as well the local explanation model and the principle can be used to aggregate any local explanation model provided by the user. The only requirement is the specification of distance measure to compare explanations.

The instantiation of MAME described in the experiments uses sparse linear models as local explanation models (just like LIME). However, other instantiations can use local explanation models such as generalized additive models, rule lists, decision trees, non-linear models, etc.

Therefore, unlike previous methods, uses explanations, multi-level explanations, and joint learning.

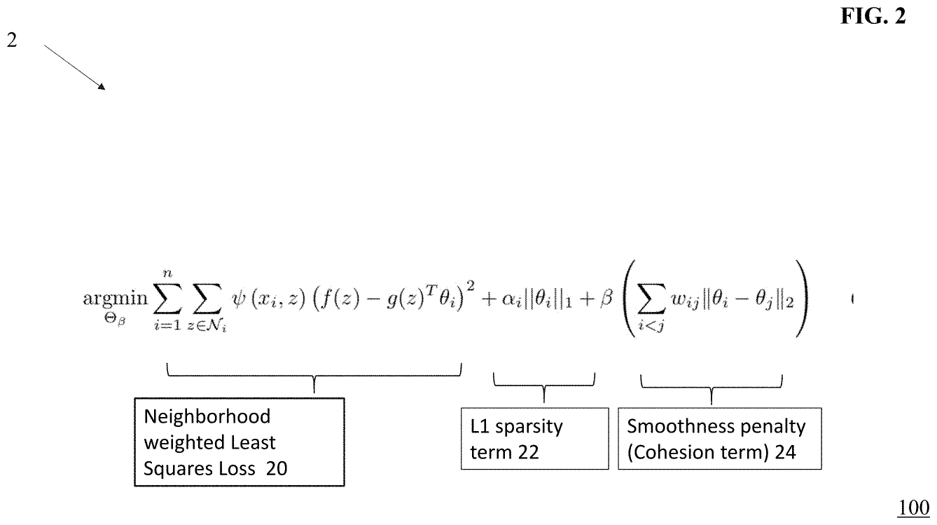

FIG. 2 illustrates the mathematical formulation in an example embodiment. Referring to FIG. 2, mathematic formulation of an example embodiment, the neighborhood weighted least squares loss 20 is provided, while 22 represents the L1 sparsity term. The formula also includes Smoothness penalty (Cohesion term) 24. The objective is that it combines the loss term to mimic blackbox predictions with two regularization terms (a) for sparsity in explanations and (b) group explanations.

The Model Agnostic Multilevel Explanation (MAME) method (: Input: Dataset x₁, . . . , xₙ, black box model ƒ(.), the coordinate wise map g(.) and (optionally) pairwise explanation similarity matrix W.

i) Sample neighborhoods [symbol] ᵢ for each example xᵢ.
ii) Solve the equation below (equation 1) for progressively increasing β values (see section 3.2) starting from β←0 (lowest level or leaves).

argmin_{Θ}_{_{β}}Σᵢ₌₁ⁿ [symbol] ψ(xᵢ,z)(ƒ(z)−g(z)^{T}θᵢ)²+αᵢ∥θᵢ∥₁+β(Σ_{i<j}wᵢⱼ∥θᵢ−θⱼ∥₂)wᵢⱼ denotes the ij^{th} entry in W.

iii) For each selected β or level, using pairwise distances between coefficient vectors Θ_{β} determine groupings T_{β} indicative of internal nodes in our tree (see section 3.2). iv) Return T_{β} and set of coefficient vectors Θ_{β} (over all n examples) for all selected (β) levels.

In this section it is first described the present method and then show how the present optimization problem can be efficiently solved using proximal methods.

Let X×Y denote the input-output space and ƒ:X→Y a classification or regression function corresponding to a black box classifier. For any positive integer k let g: [symbol] ^{k}→ [symbol] ^{k} denote a function that acts co-ordinate wise on any feature vector x∈X. Thus, if g (x) is an identity map then we recover x. However, g (.) could be non-linear where we could potentially apply even different non-linearities to different coordinates of x. If θ is a parameter vector of dimension k, then l(x, θ)=g(x)^{T}θ can be thought of as a generalized additive model which could be learned based on the predictions of ƒ(.) for examples near x thus providing a local explanation for x given by θ. Let ψ(x,z) be the similarity between x and z. This can be estimated for a distance function d(.,.) as exp(−γd(x,z)). For tabular data or images d(.,.) could be the [symbol] ₂ distance and for text this could be the cosine distance. Let (x₁,y₁), . . . , (xₙ, yₙ) denote a dataset of size n where the output yᵢ may or may not be known for each example. Let [symbol] ᵢ be the neighborhood of an example xᵢ, i.e. examples that are highly similar to xᵢ formally defined as [symbol] ᵢ={z∈X|ψ(xᵢ, z)≥γ} for a γ∈[0,1] close to 1. In practice, [symbol] ᵢ of size m can be generated by randomly perturbing xᵢ as done in previous works m times.

Given this the present system can define the following optimization problem:

argmin_{Θ}_{_{β}}Σⁱ⁼¹ⁿ [symbol] ψ(xᵢ,z)(ƒ(z)−g(z)^{T}θᵢ)²+αᵢ∥θᵢ∥₁+β(Σ_{i<j}wᵢⱼ∥θᵢ−θⱼ∥₂) (1)
where α₁, . . . , αₙ, β≥0 are regularization parameters, wᵢⱼ≥0 are custom weights (default value 1) and Θ_{β} is the set of θᵢ ∀i∈{1, . . . , n} for a given β.

The first term in the objective tries to make the local models for each example to be as faithful as possible to the black box model. This can be done similar to previous works where we sample examples in the neighborhood of the example of interest and minimize a weighted loss where the weights are indicative of the similarity of the nearby examples. The second term tries to keep each explanation θᵢ sparse. The third term tries to group together explanations. This in conjunction with the first term has the effect of trying to make explanations of similar examples to be similar. Here one has the opportunity to inject domain knowledge by setting the weights wᵢⱼ to high values for pairs of examples that one considers should have similar explanations, while setting other pairs to low values or zeros if one believes they have very little in common. A natural grouping that one could encode here is to push together explanations for examples that lie in the same class. In this case, a n×n weight matrix W containing the pairwise weights for all examples would have a block diagonal structure.

In algorithm 2, the present system solves the above objective for different values of β, where each β instantiation corresponds to a level in our multilevel explanation tree. Initially, β is set to zero which gives us decoupled local explanations which are equivalent to LIME and can be said to form the leaves of our tree. Following this β can be adaptively increased based on a schedule we describe later that selects levels that are distinct enough and progressively group together more and more examples forming higher levels in our tree.

There some example certain key differences between the present system approach and the proximal bi-clustering algorithm. The present system explores the notion of the neighborhood of any given instance while computing the objective function, (ii) our formulation is also simpler as we do not enforce both row and column-based sparsity while learning the level-wise explanations and (iii) our choice of the [symbol] ₁ regularization parameter is based on the explanation complexity and is not set simply based on cross validation based parameter tuning.

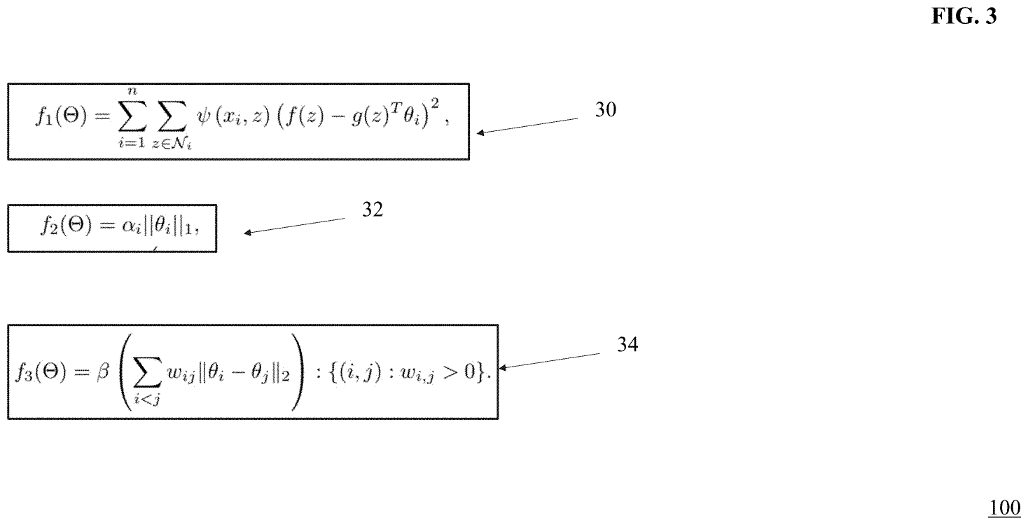

FIG. 3 illustrates the optimization in MAME in an example embodiment.

In the formulation of the present system, the proximal decomposition method isused. This is an efficient algorithm for minimizing the sum of several convex functions. The present formulation involves three such functions as given where the first term is a weighted least squares loss computed over the neighborhood, the second term is a [symbol] ₁ sparsity inducing penalty and the third is a regularization term inspired by convex clustering designed to closeness between coefficient vectors. The proximal operator definition

$$p r o {x}_{f} b = {arg min}_{a} ( f ( a ) + \frac{1}{2} {‖ b - a ‖}_{2}^{2} ) .$$

In order to use the optimization procedure in, the system 100 divide split (formula 1) into three functions, ƒ₁ 30, ƒ₂ 32 and ƒ₃ 34 as below.

ƒ₁(Θ)= [symbol] ψ(xᵢ,z)(ƒ(z)−g(z)^{T}θᵢ)², (32)

ƒ₂(Θ)=αᵢ∥θᵢ∥₁, (34)

ƒ₃(Θ)=β(Σ_{i<j}wᵢⱼ∥θᵢ−θⱼ∥₂):{(i,j):w_{i,j}>0}. (36)

The proximal operator of the weighted least squares term, ƒ₁, can be computed trivially. ƒ₁ with the neighborhood weighted Least Squares Loss enforce fidelity with regard to the blackbox predictions 32.

For ƒ₂, the proximal is the same as soft-thresholding operator. ƒ₂ shows explanation sparsity, where it controls explanation complexity 34.

Since the proximal operator for ƒ₃ is equivalent to convex clustering on 0 with a given regularization, the present system leverages existing efficient convex clustering implementations. ƒ₃ shows cohesion term for natural grouping of explanations (creates the tree) 36.

We use these along with the methods proposed in to solve (1).

At a high level the proximal algorithm begins by computing an overall average estimate over the initialized vectors for each of the three functions. We then follow an iterative routine where in the proximal operators for each of the three components are computed and used to update the solution vector until convergence is reached. The full algorithm is provided in the supplementary material.

In this section there is provided some desirable theoretical properties for the present method.

Now shown is the present method actually forms a tree in that explanations of examples that are close together at lower levels will remain at least equally close at higher levels.

(Non-expansive map) If β₁, . . . , βₖ are regularization parameters for the last term in equation 1 for k consecutive levels in our multilevel explanations where βᵢ=0 is the lowest level with θᵢ^{(p)} and θⱼ^{(p)} denoting the (globally) optimal coefficient vectors (or explanations) for xᵢ and xⱼ respectively corresponding to level p∈{1, . . . , k}, then for p>1 and wᵢⱼ>0 we have

∥θᵢ^{(p)}−θⱼ^{(p)}∥₂≤∥θᵢ^{(p-1)}−θⱼ^{(p-1)}∥₂.

Proof Sketch. If Oₚ denotes the objective in equation 1 being optimized at level p, then Oₚ=Oₚ₋₁+Δₚ(Σ_{i<j} wᵢⱼ∥θᵢ−θⱼ∥₂), where Δₚ=βₚ−βₚ₋₁. We know that Δₚ>0 by design and so we have an added penalty.

If at the optimal of level p, ∥θᵢ^{(p)}−θⱼ^{(p)}∥₂>∥θᵢ^{(p-1)}−θⱼ^{(p-1)}∥₂ for some xᵢ and xⱼ, then that would imply that the other two terms in the objective reduce enough to compensate for the added penalty. However, this would imply that θᵢ^{(p-1)} and θⱼ^{(p-1)} were not the optimal solution at level p−1 as the current solution would be better given the lesser emphasis on the last term (i.e. lesser β) at that level. This contradicts our assumption. Any threshold γ(≥∥θᵢ^{(p)}−θⱼ^{(p)}∥₂) used to group examples to form internal nodes at a level will thus keep them together even at higher levels.

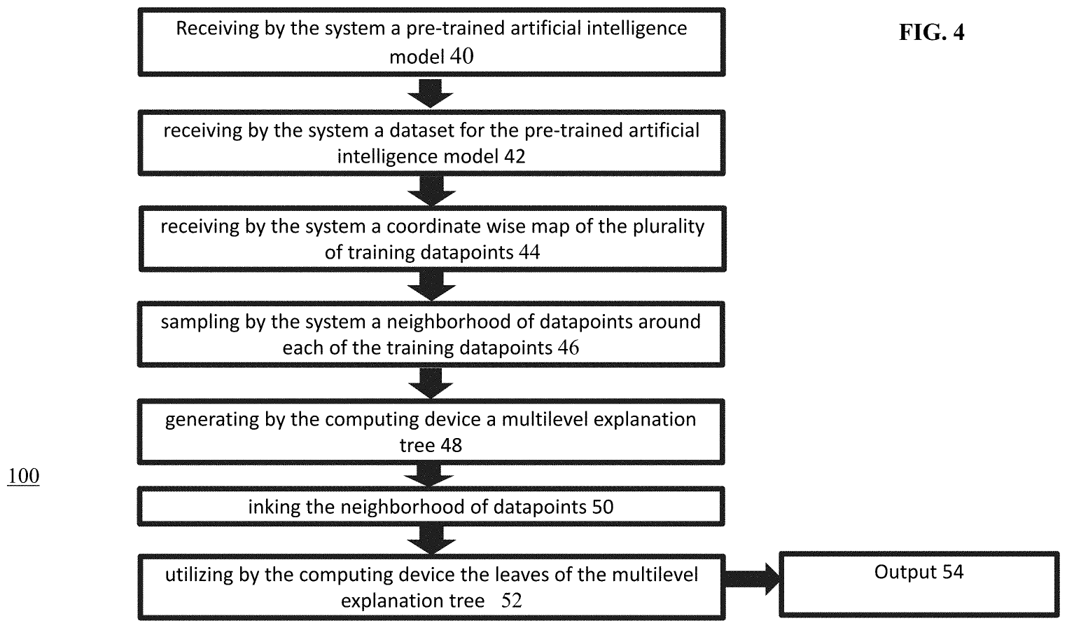

FIG. 4 illustrates the method for the system in an example embodiment.

Referring to FIG. 4, the system 100 shows the method of using a computing device to explain one or more predictions of a machine learning model. The method includes receiving by a computing device a pre-trained artificial intelligence model with one or more predictions 40, receiving by the computing device a dataset for the pre-trained artificial intelligence model containing a plurality of training datapoints 42, receiving by the computing device a coordinate wise map of the plurality of training datapoints 44, sampling by the computing device a neighborhood of datapoints around each of the training datapoints 46, generating by the computing device a multilevel explanation tree 48, linking the neighborhood of datapoints around each of the training datapoints to the one or more predictions, leaves of the multilevel explanation tree representing the neighborhood of datapoints around each of the training datapoints and distances between leaves of the multilevel explanation tree indicating differences between values of the neighborhood of datapoints 50, and utilizing by the computing device the leaves of the multilevel explanation tree representing the neighborhood of datapoints to explain one or more predictions of the machine learning model 52, to provide an output 54.

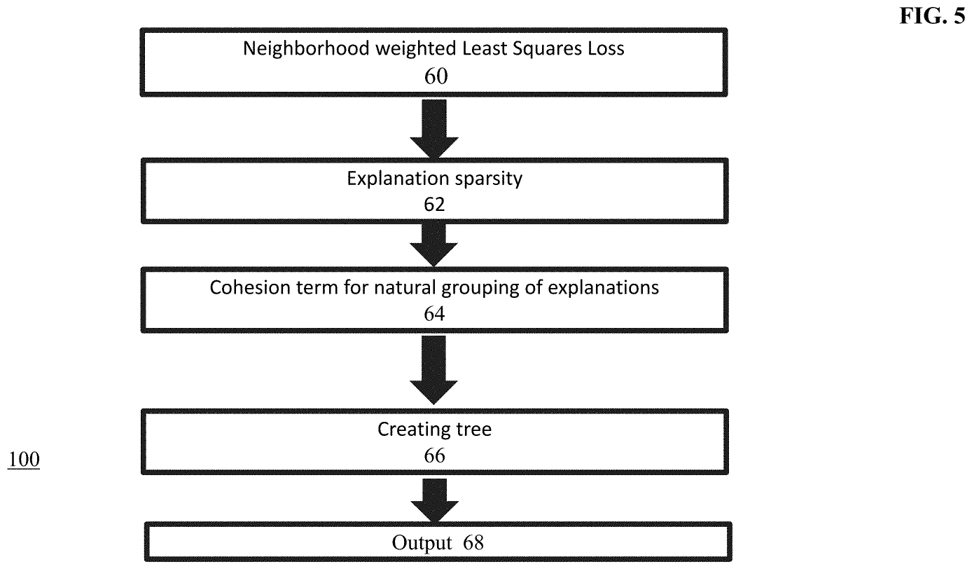

FIG. 5 illustrates the method for the system in an example embodiment.

Referring to FIG. 5 and also FIGS. 2 and 3, the system 100 computes neighborhood weighted least squares loss 60, while also determining the L1 explanation sparsity term 62. The system 100 also determines Smoothness penalty (Cohesion term) for natural grouping of explanations 64 to create the tree 64 and then to finally provide an output of the results 68. The objective is that it combines the loss term to mimic blackbox predictions with two regularization terms (a) for sparsity in explanations and (b) group explanations.

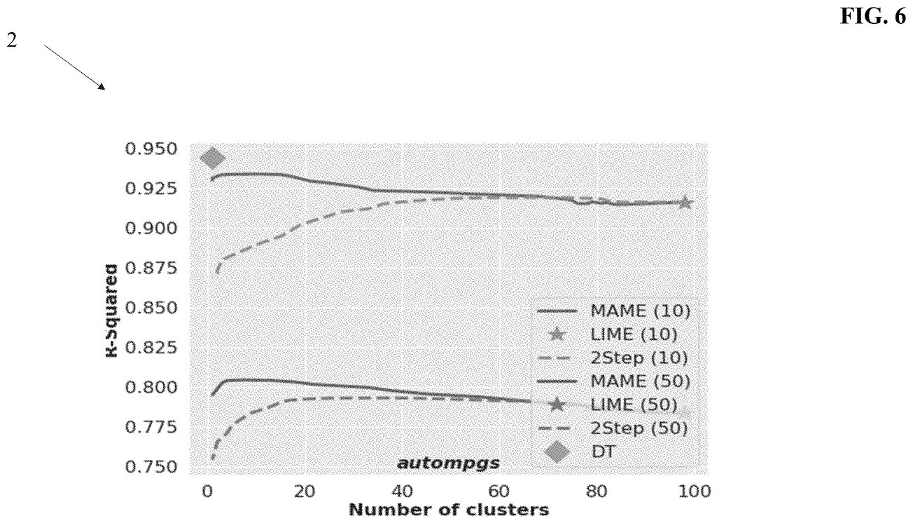

Referring to FIGS. 6 through 11, we see the Generalized Fidelity of the different methods for the same number of clusters corresponding to different levels in the trees for the 5 public datasets. This is reported for two different neighborhood sizes of 10 and 50 for UCI datasets and 50 for Oil & Gas as we wanted to present the expert with a single tree. We see that our method is consistently superior to 2-step. DT trained on the black box models predictions has similar or worse performance than us on all UCI datasets except one. It isn't applicable in the Oil & Gas case as the expert imposed constraints of having certain examples have similar explanations which it violated as we cannot enforce it.

We now empirically compare our method to other appropriate baselines for our setting. We first describe the setup followed by a discussion of the main findings.

Practical Example Applications

We consider datasets from the UCI repository and real-world dataset from for example the Oil & Gas industry and other real world datasets. Regression experiments were done with five pubic UCI datasets and the classification experiment was done on a proprietary Oil & Gas dataset. Our experiments wish to evaluate primarily two things. i) Generalized Fidelity: How trustworthy the learned local explanation models are at different levels in the tree. ii) Smoothness: How consistent or smooth are the explanations as we move from one level to the next. The smoother the transition the more easily understandable they are likely to be given that they are already sparse.

The system 100 performs experiments on 5 real publicly available UCI datasets namely; autompg, communities, happiness, music and day, where the target is real valued (details in supplement). In addition, system 100 also perform a case study with a real-world industrial pump failure dataset (classification dataset) from the Oil & Gas industry and evaluate our explanations based on expert feedback (sample explanations in supplement). Each dataset was randomly split (10 times) into 3 parts of size 50%, 25% and 25%. The first 50% is used to train the black box model which was a random forest of size 100 for the public datasets and the Oil & Gas case. The next 25% was used to train the explanation models such as LIME, decision tree (DT) and the present system 100 is based on the black box models predictions. Moreover, a 2-step convex clustering approach using the independently LIME learned explanations to form an explanation tree was also used as a baseline. The last 25% was used as test based on which all results are reported.

The [symbol] ᵢ regularization parameter for the LIME based methods is selected for each instance based on the desired explanation complexity which was set to 5 for the results reported here. For the [symbol] ₂ regularization parameter for our method and 2-step we sweep across a sequence of values to build the tree where each value corresponds to a unique level. wᵢⱼ for examples xᵢ and xⱼ is set to 1 if xᵢ is amongst the 10 nearest neighbors of xᵢ or vice-versa, else it is 0.

The Quantitative Metrics are as follows. The system 100 evaluates primarily two things. i) How trustworthy the learned local explanation models are at different levels in the tree and ii) how consistent or smooth are the explanations as we move from 1 level to the next. The smoother the transition the more easily understandable they are likely to be given that they are already sparse. Based on this we propose two metrics:

The generalized fidelity is as follows. Generalized Fidelity (y-axis) for the same number of clusters (x-axis) corresponding to different levels in the trees (See FIGS. 6 through 11). This is reported for two different neighborhood sizes of 10 and 50. Comparisons is shown between MAME, 2Step, LIME, and a decision tree learned directly on the data.

Here, except for DT, for every example in the test set we find the closest example based on euclidean distance (1-nearest neighbor) in the set that the explanation models were built and use that explanation as a proxy for the test example. Then computaton of the error w.r.t. the black box models prediction is made. If this error over all test examples is low (or R-squared is high) then, that implies that the local models at that particular level capture the behavior of the black box model accurately and thus can be trusted. For the present method and 2-step one does this for each level in the tree and compare the levels that have the same number of groups/clusters as the depth of the trees may vary. For DT the inventors just use the model to obtain predictions for the test examples.

The smoothness is provided as follows. Here we want to see how smooth the transitions are from level to level of the reported explanations for our method and 2-step. If L (>1) is the number of levels in the tree and θᵢⱼ is the explanation vector for example xᵢ at level j, then we compute smoothness of explanation for an example xᵢ as follows:

$$1 - \frac{1}{L} {\sum }_{j = 1}^{L - 1} {‖ {θ}_{i j} - {θ}_{i j + 1} ‖}_{1} .$$

Overall smoothness as reported in Table 1 is computed by averaging this value over all examples (more details in supplement).

We first discuss our results on the public datasets followed by a discussion of the pump failure dataset.

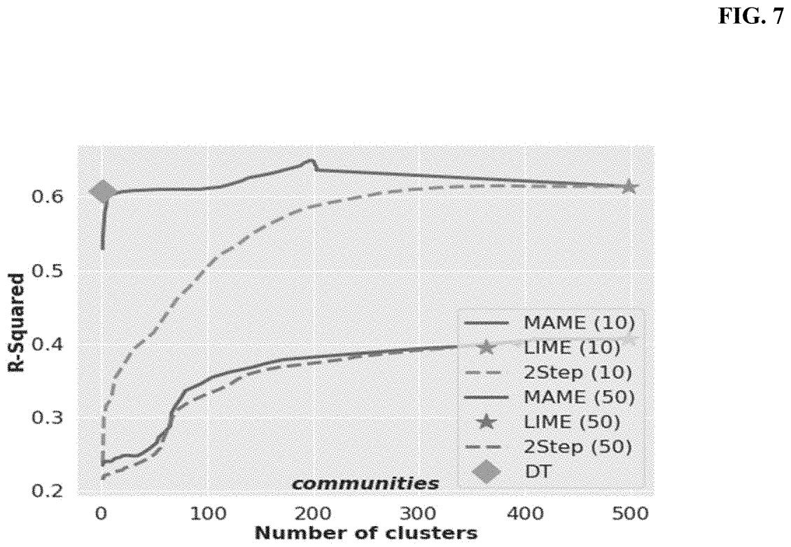

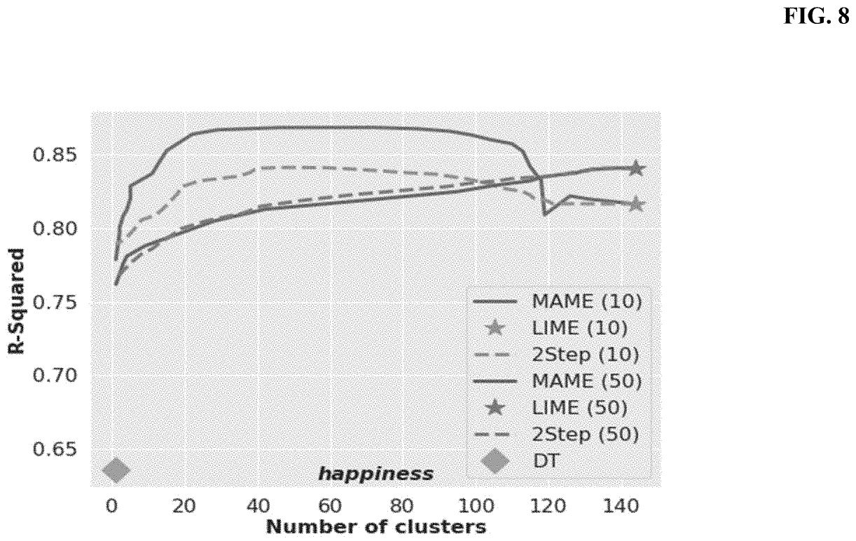

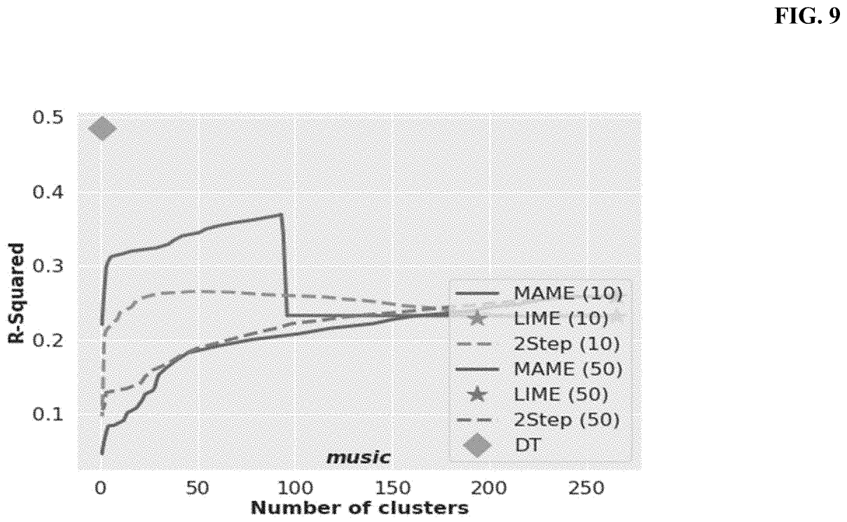

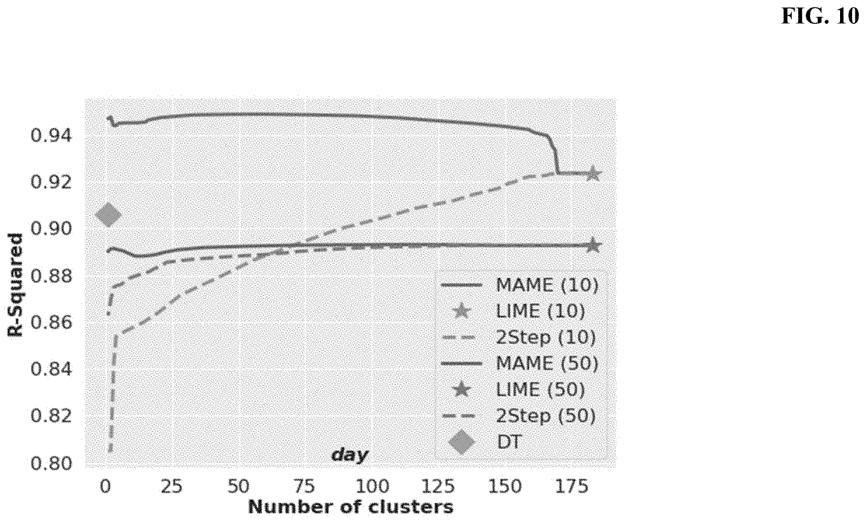

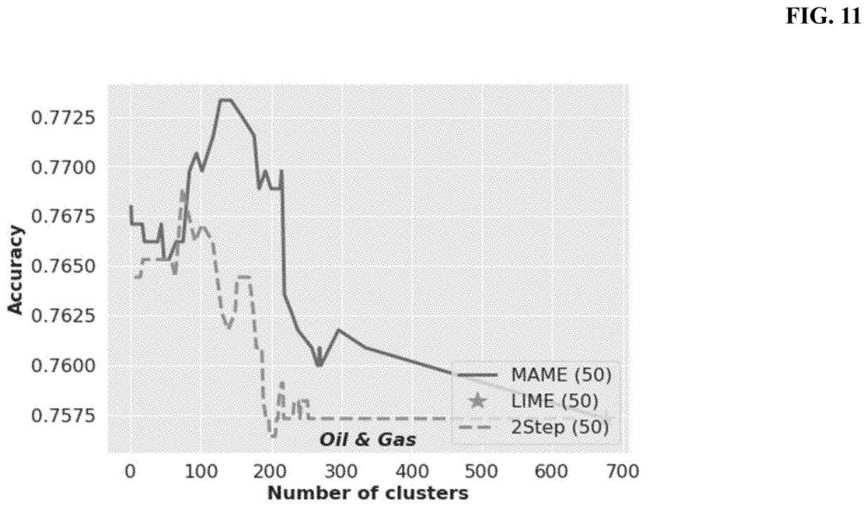

FIG. 6 illustrates the application results for automgs. FIG. 7 illustrates the application results for communities. FIG. 8 illustrates the application results for happiness. FIG. 9 illustrates the application results for music. FIG. 10 illustrates the application results for day. FIG. 11 illustrates the application results for Oil & Gas.

On the 5 public datasets we observe in FIGS. 6 through 11 that the present method, in most cases, is significantly better than 2-step at levels in the trees that have the same number of clusters or nodes i.e. we generalize better. In fact, we are similar or better than a distilled DT, in all cases except one. In many cases we see that the intermediate levels also have better performance than standard LIME, where explanations are learned independently. This shows that there may be a point (i.e. a level) of optimal bias-variance trade-off where constraining the explanations to be close actually makes them more accurate or fidel to the black box model.

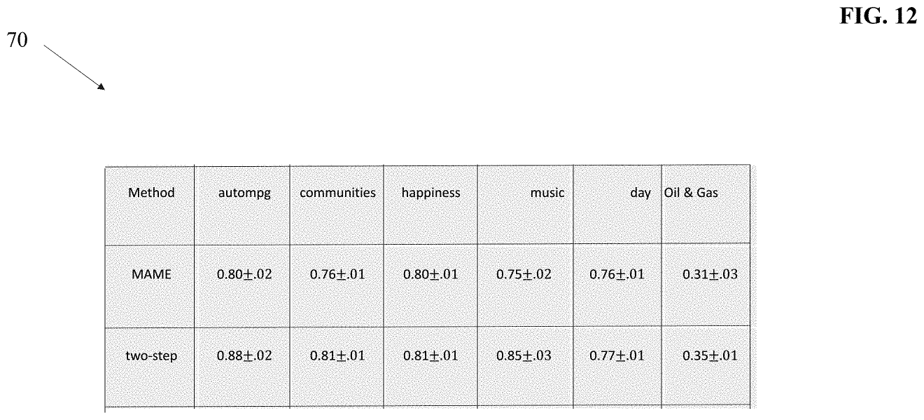

FIG. 12 illustrates the comparison of the MAME system and the step method. In Table 70, we observe that our explanations are almost as smooth as 2-step which is consistently worse than us when it comes to generalized fidelity. This implies that although we may be losing out a bit on smoothness we gain a lot when it comes to fidelity and so our tree should in general be the preferred option.

Table 70: Smoothness results for the 5 UCI datasets and the Oil & Gas dataset based on average change in parameter values from one level to the next averaged over all levels and all the examples in the tree. We see here that our method is almost as smooth as 2-step, while being much more fidel as seen in the figures.

Oil & Gas Industry data sets are as follows. The pump failure dataset we analyzed here consists of sensor readings acquired from 2500 oil wells over a period of four years that contains pumps to push out oil. These sensor readings consist of measurements such as speed, torque, casing pressure, production and efficiency for the well along with the type of failure category diagnosed by the engineer. In this dataset, there are three major failure modes: Worn, Reservoir and Pump Fit. Worn implies the pump is worn out because of aging. Reservoir implies the pump has a physical defect. Pump fit implies there is sand in the pump.

Amongst these 3 failure modes Reservoir is hardest to predict and so the domain expert was particularly interested in this failure mode. Moreover, he wanted to enforce that explanations for certain groups of examples from the Worn and Reservoir classes remain close. DT was unable to do this so we report results on our tree and the 2-step tree, which are able to model this information. In a blind analysis of the trees, the following results were shown. In each case the evaluator followed a path in the tree from root to leaves where there were many reservoir failures. For the present system, the evaluator found that at higher levels in the tree we almost exclusively highlighted casing pressure as the most important feature and speed as the second most important factor. At lower levels in our tree their importance was switched with these two factors and production being highlighted. As it turns out based on domain knowledge these are the two most important factors. 2-step highlighted casing pressure but also a few other features such as speed and torque which in particular has little to do with this defect. Given this the expert felt that our tree explanations were most accurate and the smooth (as well as sparse) transition of feature importances also made the explanation tree appear more robust to the expert.

It is observed in FIG. 1 that the explanation tree also generalizes well and has high test performance. This was somewhat confirmed by the experts feedback when we validated the features selected by our tree. Again looking at Table 70 in FIG. 12 we see that statistically we have the same smoothness as 2-step in this case (more details in supplement).

The approach proposed in this paper is highly flexible. Given the prox operators and the (decoupled) manner in which we optimize the objective more general forms of local explainability techniques could be used as long as we have access or can estimate the gradient of the first loss term. Also loss functions other than squared loss could be used to quantify the difference in predictions between the black box model and the local explanation method. If the loss function is convex our theoretical guarantees should still prevail. Given that our method in general has superior generalized fidelity to the other methods it could be used to obtain explanations in real time for test examples without having to build local models for each of these examples. This can lead to significant savings in time and even money if the model we are trying to explain lies in a different users cloud environment where every query has an associated cost. This is an extremely relevant use case as companies allow access to assets in their environment but at a cost which is usually a function of the number of queries. In summary, we have provided a general framework to learn multilevel explanations from local linear or non-linear explainability methods. The framework allows one to specify instances whose explanations should be similar as seen in the Oil & Gas case study. We have shown that not only does our method generalize well but also creates smoothly graded coherent explanations in a fluid way that convey in a sense a more complete story.

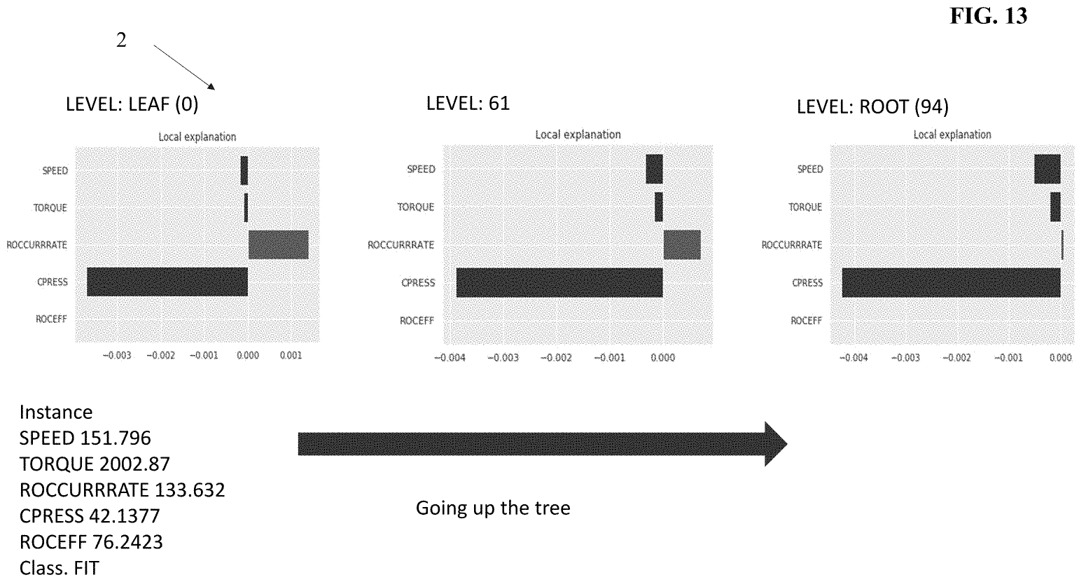

FIG. 13 illustrates Two Step transition across levels for a sample instance. The graphs show going up the tree from leaf 0, leaf 61 and leaf 94 the root for the two-step method.

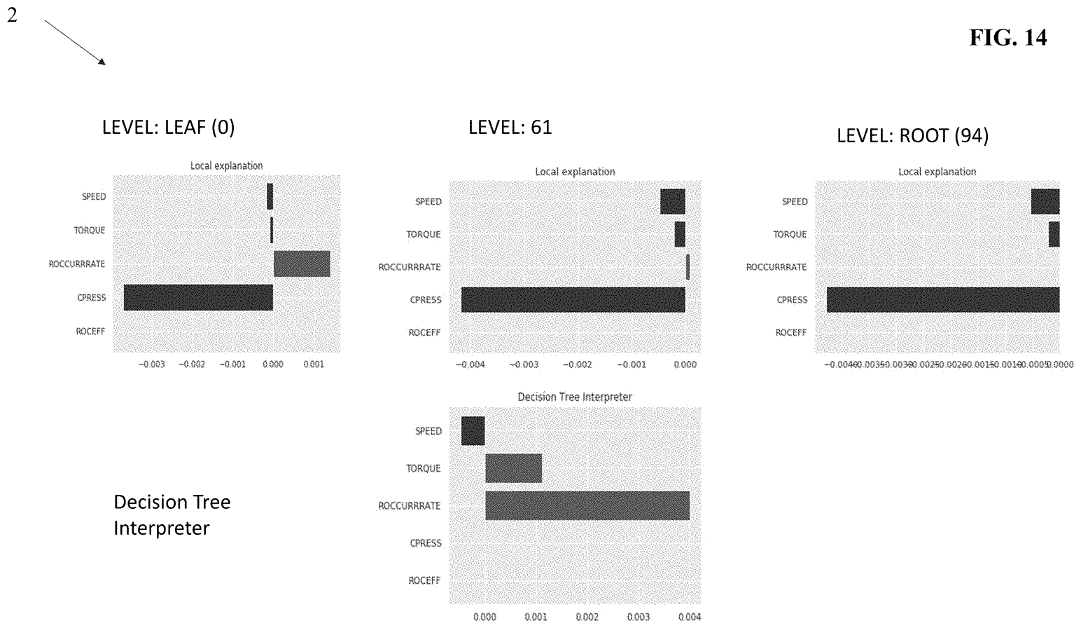

FIG. 14 illustrates the MAME explanation transition across levels for a sample instance. The graphs show going up the tree from leaf 0, leaf 61 and leaf 94 the root for the present MAME method. The decision tree interpreter shows the improvement over the two-step method of FIG. 13.

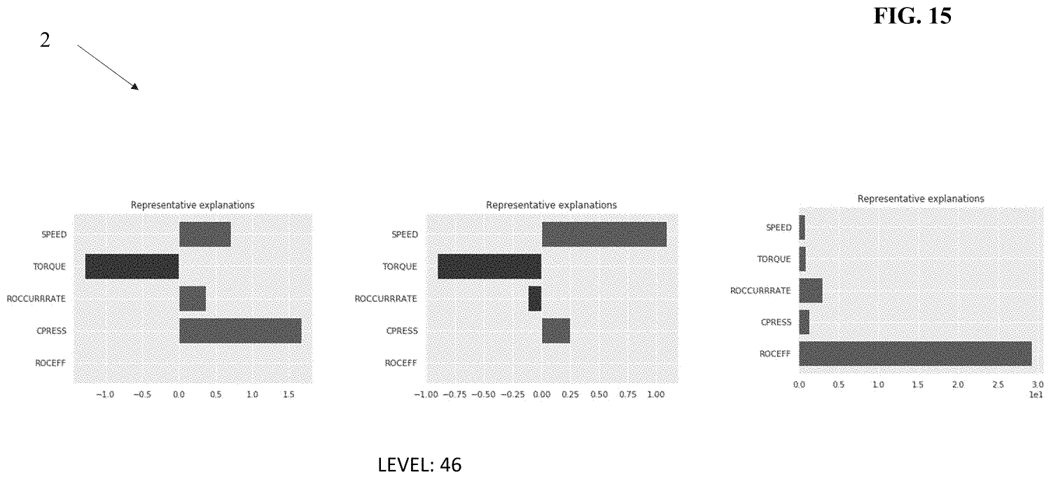

FIG. 15 illustrates the 5 representative explanations for a given level for Reservoir tree at level 46.

Therefore, the present System and Method 100 is able to generate multilevel explanations, (a) based linear (viz. LIME) or non-linear (viz. GAM) local explainability techniques, (b) that can take into account constraints on points that should have similar explanations, (c) that smoothly transition between levels leading to better consumability, and (d) that can provide fast and accurate local explanations (optimal level).

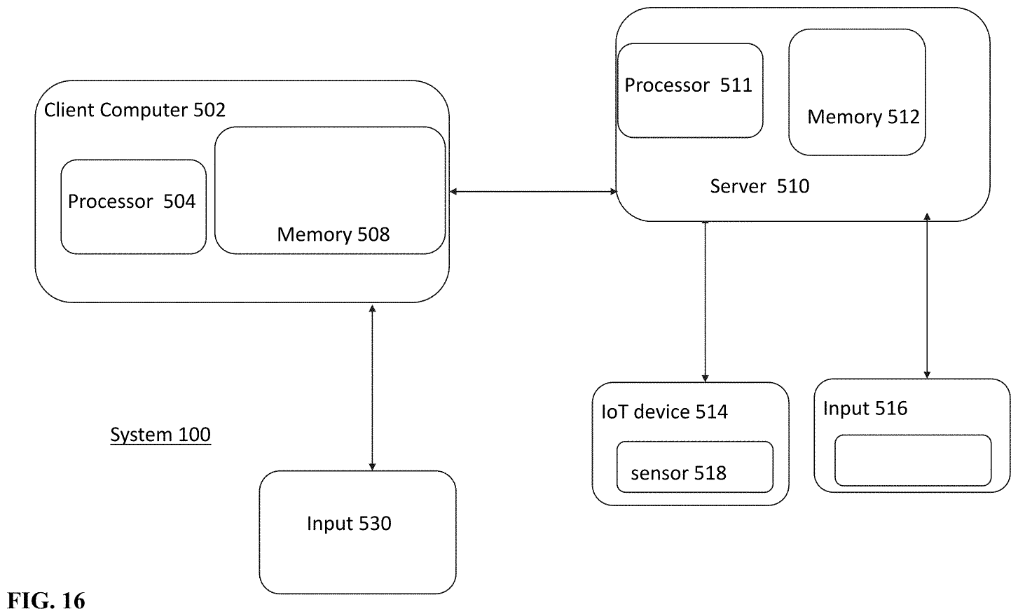

FIG. 16 illustrates an example implementation. With the method described, client software being executed by the client 502 or server computer 510. The server 510 can be cloud implemented. The client computer device 502 can include a processor 504 and memory 508. The server 510 can include a processor 511 and a memory 512. The software can be stored in either or both memories 508 or 512, which are executed by processors 504 and 511, respectively.

Input can be provided by input device 530 or 516, or from different IoT (Internet of Things) devices 514 that can include sensors 518. The server memory 512 can be cloud storage.

With reference back to FIG. 4, the system 100 shows the method of using a computing device to explain one or more predictions of a machine learning model. The method includes receiving by a computing device 502 or 504 a pre-trained artificial intelligence model with one or more predictions 40, receiving by the computing device 502 or 504 a dataset for the pre-trained artificial intelligence model containing a plurality of training datapoints 42, receiving by the computing device 502 or 504 a coordinate wise map of the plurality of training datapoints 44, sampling by the computing device a neighborhood of datapoints around each of the training datapoints 46, generating by the computing device 502 or 504 a multilevel explanation tree 48, linking the neighborhood of datapoints around each of the training datapoints to the one or more predictions, leaves of the multilevel explanation tree representing the neighborhood of datapoints around each of the training datapoints and distances between leaves of the multilevel explanation tree indicating differences between values of the neighborhood of datapoints 50, and utilizing by the computing device the leaves of the multilevel explanation tree representing the neighborhood of datapoints to explain one or more predictions of the machine learning model 52, to provide an output 54 that can be sent to a display device or another system.

FIG. 16 illustrates an example configuration of the example embodiment. The system 100 includes a client computer 502, which communicates with the server 510. The server 510 communicates with the IoT devices 514 and input device 516. The Client computer 502 includes a processor that executes the program in memory 508. The server 510 stores information in memory 512 received from the IoT devices 514 and input device 516. The IoT device 514 can includes a sensor 518. The client computer 502, server 510 and IoT devices 514 and input devices 516 and 530 are connected through a network for the system 100.

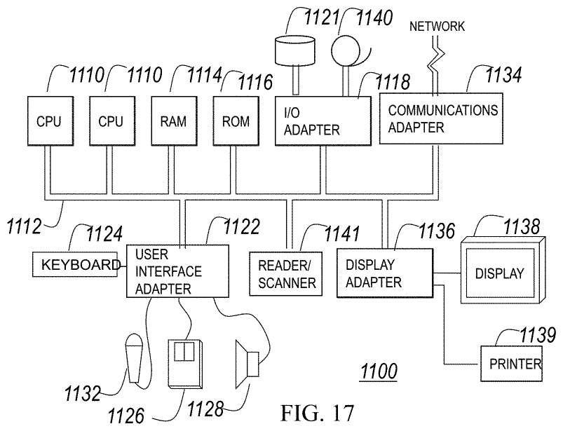

FIG. 17 illustrates another hardware configuration of the system 100, where there is an information handling/computer system 1100 in accordance with the present invention and which preferably has at least one processor or central processing unit (CPU) 1110 that can implement the techniques of the invention in a form of a software program.

The CPUs 1110 are interconnected via a system bus 1112 to a random access memory (RAM) 1114, read-only memory (ROM) 1116, input/output (I/O) adapter 1118 (for connecting peripheral devices such as disk units 1121 and tape drives 1140 to the bus 1112), user interface adapter 1122 (for connecting a keyboard 1124, mouse 1126, speaker 1128, microphone 1132, and/or other user interface device to the bus 1112), a communication adapter 1134 for connecting an information handling system to a data processing network, the Internet, an Intranet, a personal area network (PAN), etc., and a display adapter 1136 for connecting the bus 1112 to a display device 1138 and/or printer 1139 (e.g., a digital printer or the like).

In addition to the hardware/software environment described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

Thus, this aspect of the present invention is directed to a programmed product, including signal-bearing storage media tangibly embodying a program of machine-readable instructions executable by a digital data processor incorporating the CPU 1110 and hardware above, to perform the method of the invention.

This signal-bearing storage media may include, for example, a RAM contained within the CPU 1110, as represented by the fast-access storage for example.

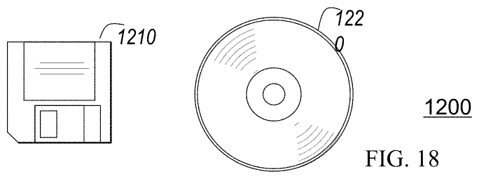

Alternatively, the instructions may be contained in another signal-bearing storage media 1200, such as a magnetic data storage diskette 1210 or optical storage diskette 1220 (FIG. 18), directly or indirectly accessible by the CPU 1210.

Whether contained in the diskette 1210, the optical disk 1220, the computer/CPU 1210, or elsewhere, the instructions may be stored on a variety of machine-readable data storage media.

Therefore, the present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which includes one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

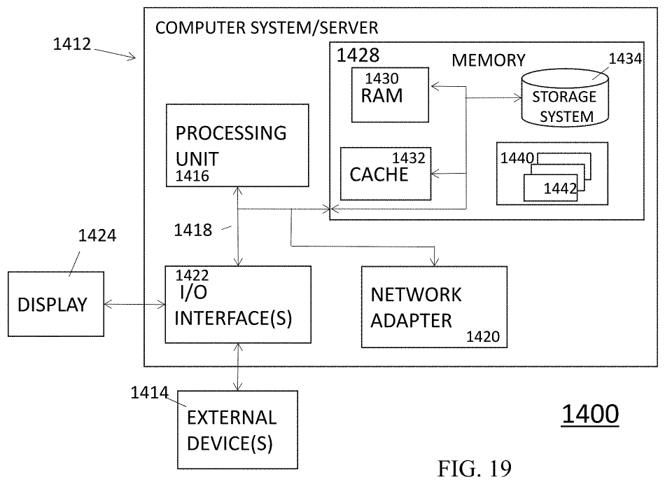

Referring now to FIG. 19, a schematic 1400 of an example of a cloud computing node is shown. Cloud computing node 1400 is only one example of a suitable cloud computing node and is not intended to suggest any limitation as to the scope of use or functionality of embodiments of the invention described herein. Regardless, cloud computing node 1400 is capable of being implemented and/or performing any of the functionality set forth hereinabove.

In cloud computing node 1400 there is a computer system/server 1412, which is operational with numerous other general purpose or special purpose computing system environments or configurations. Examples of well-known computing systems, environments, and/or configurations that may be suitable for use with computer system/server 1412 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 1412 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 1412 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 19, computer system/server 1412 in cloud computing node 1400 is shown in the form of a general-purpose computing device. The components of computer system/server 1412 may include, but are not limited to, one or more processors or processing units 1416, a system memory 1428, and a bus 1418 that couples various system components including system memory 1428 to processor 1416.

Bus 1418 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 1412 typically includes a variety of computer system readable media. Such media may be any available media that is accessible by computer system/server 1412, and it includes both volatile and non-volatile media, removable and non-removable media.

System memory 1428 can include computer system readable media in the form of volatile memory, such as random-access memory (RAM) 1430 and/or cache memory 1432. Computer system/server 1412 may further include other removable/non-removable, volatile/non-volatile computer system storage media. By way of example only, storage system 1434 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 1418 by one or more data media interfaces. As will be further depicted and described below, memory 1428 may include at least one program product having a set (e.g., at least one) of program modules that are configured to carry out the functions of embodiments of the invention.

Program/utility 1440, having a set (at least one) of program modules 1442, may be stored in memory 1428 by way of example, and not limitation, as well as an operating system, one or more application programs, other program modules, and program data. Each of the operating system, one or more application programs, other program modules, and program data or some combination thereof, may include an implementation of a networking environment. Program modules 1442 generally carry out the functions and/or methodologies of embodiments of the invention as described herein.

Computer system/server 1412 may also communicate with one or more external devices 1414 such as a keyboard, a pointing device, a display 1424, etc.; one or more devices that enable a user to interact with computer system/server 1412; and/or any devices (e.g., network card, modem, etc.) that enable computer system/server 1412 to communicate with one or more other computing devices. Such communication can occur via Input/Output (I/O) interfaces 1422. Still yet, computer system/server 1412 can communicate with one or more networks such as a local area network (LAN), a general wide area network (WAN), and/or a public network (e.g., the Internet) via network adapter 1420. As depicted, network adapter 1420 communicates with the other components of computer system/server 1412 via bus 1418. It should be understood that although not shown, other hardware and/or software components could be used in conjunction with computer system/server 1412. Examples, include, but are not limited to: microcode, device drivers, redundant processing units, external disk drive arrays, RAID systems, tape drives, and data archival storage systems, etc.

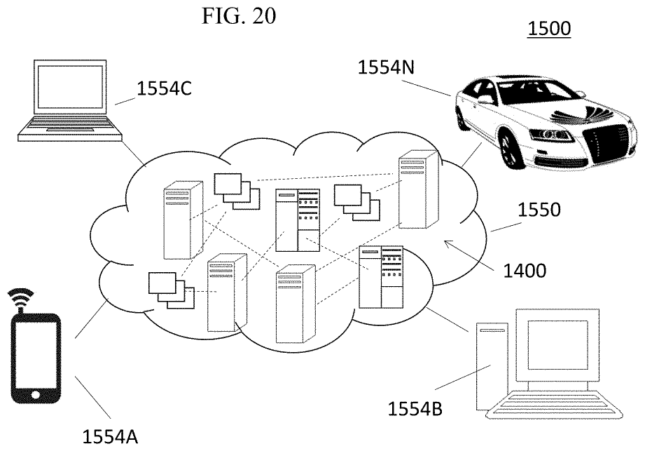

Referring now to FIG. 20, illustrative cloud computing environment 1550 is depicted. As shown, cloud computing environment 1550 includes one or more cloud computing nodes 1400 with which local computing devices used by cloud consumers, such as, for example, personal digital assistant (PDA) or cellular telephone 1554A, desktop computer 1554B, laptop computer 1554C, and/or automobile computer system 1554N may communicate. Nodes 1400 may communicate with one another. They may be grouped (not shown) physically or virtually, in one or more networks, such as Private, Community, Public, or Hybrid clouds as described hereinabove, or a combination thereof. This allows cloud computing environment 1550 to offer infrastructure, platforms and/or software as services for which a cloud consumer does not need to maintain resources on a local computing device. It is understood that the types of computing devices 1554A-N shown in FIG. 20 are intended to be illustrative only and that computing nodes 1400 and cloud computing environment 1550 can communicate with any type of computerized device over any type of network and/or network addressable connection (e.g., using a web browser).

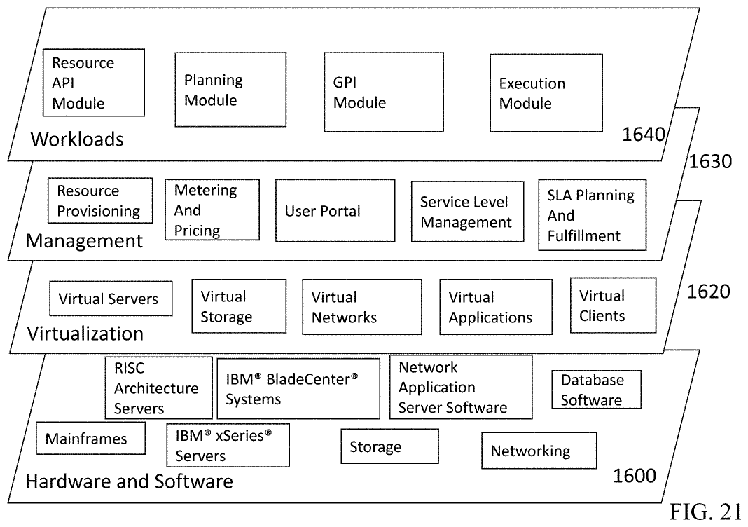

Referring now to FIG. 21, a set of functional abstraction layers provided by cloud computing environment 1550 (FIG. 20) is shown. It should be understood in advance that the components, layers, and functions shown in FIG. 21 are intended to be illustrative only and embodiments of the invention are not limited thereto. As depicted, the following layers and corresponding functions are provided:

Hardware and software layer 1660 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, Web Sphere, and DB2 are trademarks of International Business Machines Corporation registered in many jurisdictions worldwide).

Virtualization layer 1662 provides an abstraction layer from which the following examples of virtual entities may be provided: virtual servers; virtual storage; virtual networks, including virtual private networks; virtual applications and operating systems; and virtual clients.

In one example, management layer 1664 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 1666 provides examples of functionality for which the cloud computing environment may be utilized. Examples of workloads and functions which may be provided from this layer include such functions as mapping and navigation; software development and lifecycle management; virtual classroom education delivery; data analytics processing; transaction processing; and, more particularly relative to the present invention, the APIs and run-time system components of generating search autocomplete suggestions based on contextual input.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

It is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

What is claimed is:

1. A method of machine learning, the method comprising:
receiving by a computing device a pre-trained artificial intelligence model with one or more predictions;
generating by the computing device a multilevel explanation tree, linking neighborhood of datapoints around each of a plurality of training datapoints to the one or more predictions; and
utilizing by the computing device the multilevel explanation tree to explain one or more predictions of the machine learning model.

2. The method of claim 1, further comprising receiving by the computing device a dataset for the pre-trained artificial intelligence model including the plurality of training datapoints.

3. The method of claim 2, further comprising of receiving by the computing device a coordinate wise map of the plurality of training datapoints.

4. The method of claim 3, further comprising sampling by the computing device a neighborhood of datapoints around each of the training datapoints.

5. The method of claim 4, wherein the generating by the computing device the multilevel explanation tree, links the neighborhood of datapoints around each of the training datapoints to the one or more predictions, leaves of the multilevel explanation tree representing the neighborhood of datapoints around each of the training datapoints and distances between leaves of the multilevel explanation tree indicating differences between values of the neighborhood of datapoints, and
wherein a linear or non-linear local explainability is implemented.

6. The method of claim 1, wherein the generating by the computing device the multilevel explanation tree, links the neighborhood of datapoints around each of the training datapoints to the one or more predictions, leaves of the multilevel explanation tree representing the neighborhood of datapoints around each of the training datapoints and distances between leaves of the multilevel explanation tree indicating differences between values of the neighborhood of datapoints, and
wherein the utilizing by the computing device includes the leaves of the multilevel explanation tree representing the neighborhood of datapoints to explain one or more predictions of the machine learning model.

7. The method of claim 1, wherein the utilizing by the computing device includes the leaves of the multilevel explanation tree representing the neighborhood of datapoints to explain one or more predictions of the machine learning model,
wherein leaves of the multilevel explanation tree provides local sample-wise explanations, a root of the multilevel explanation tree provides global dataset-level explanation, and intermediate levels of the multilevel explanation tree provides explanations of clusters of data.

8. The method according to claim 1 being cloud implemented.

9. A system for explaining one or more predictions of a machine learning model, comprising:
a computer, comprising:
a memory storing computer instructions; and
a processor configured to execute the computer instructions to:
receive a pre-trained artificial intelligence model with one or more predictions;
generate a multilevel explanation tree, linking neighborhood of datapoints around each of a plurality of training datapoints to the one or more predictions; and
utilize the multilevel explanation tree to explain one or more predictions of the machine learning model.

10. The system according to claim 9, further comprising receiving a dataset for the pre-trained artificial intelligence model including the plurality of training datapoints.

11. The system according to claim 10, further comprising of receiving a coordinate wise map of the plurality of training datapoints.

12. The system according to claim 11, further comprising sampling a neighborhood of datapoints around each of the training datapoints,
wherein leaves of the multilevel explanation tree provides local sample-wise explanations, a root of the multilevel explanation tree provides global dataset-level explanation, and intermediate levels of the multilevel explanation tree provides explanations of clusters of data.

13. The system according to claim 12, wherein the generating the multilevel explanation tree, links the neighborhood of datapoints around each of the training datapoints to the one or more predictions, leaves of the multilevel explanation tree representing the neighborhood of datapoints around each of the training datapoints and distances between leaves of the multilevel explanation tree indicating differences between values of the neighborhood of datapoints, and
wherein a linear or non-linear local explainability is implemented.

14. The system according to claim 9, wherein the generating the multilevel explanation tree, links the neighborhood of datapoints around each of the training datapoints to the one or more predictions, leaves of the multilevel explanation tree representing the neighborhood of datapoints around each of the training datapoints and distances between leaves of the multilevel explanation tree indicating differences between values of the neighborhood of datapoints, and
wherein the utilizing includes the leaves of the multilevel explanation tree representing the neighborhood of datapoints to explain one or more predictions of the machine learning model.

15. The system according to claim 9, wherein the utilizing includes utilizing of leaves of the multilevel explanation tree representing the neighborhood of datapoints to explain one or more predictions of the machine learning model.

16. A computer program product comprising a computer readable storage medium having program instructions embodied therewith, the program instructions readable and executable by a computer to cause the computer to perform a method, comprising:
receive a pre-trained artificial intelligence model with one or more predictions;
generate a multilevel explanation tree, linking neighborhood of datapoints around each of a plurality of training datapoints to the one or more predictions; and
utilize the multilevel explanation tree to explain one or more predictions of the machine learning model.

17. The computer program product according to claim 16, further comprising:
receiving a dataset for the pre-trained artificial intelligence model including the plurality of training datapoints; and
receiving a coordinate wise map of the plurality of training datapoints,
wherein leaves of the multilevel explanation tree provides local sample-wise explanations, a root of the multilevel explanation tree provides global dataset-level explanation, and intermediate levels of the multilevel explanation tree provides explanations of clusters of data.

18. The computer program product according to claim 16, wherein the generating the multilevel explanation tree, links the neighborhood of datapoints around each of the training datapoints to the one or more predictions, leaves of the multilevel explanation tree representing the neighborhood of datapoints around each of the training datapoints and distances between leaves of the multilevel explanation tree indicating differences between values of the neighborhood of datapoints, and
wherein a linear or non-linear local explainability is implemented.

19. The computer program product according to claim 16, wherein the generating the multilevel explanation tree, links the neighborhood of datapoints around each of the training datapoints to the one or more predictions, leaves of the multilevel explanation tree representing the neighborhood of datapoints around each of the training datapoints and distances between leaves of the multilevel explanation tree indicating differences between values of the neighborhood of datapoints, and
wherein the utilizing includes utilizing leaves of the multilevel explanation tree representing the neighborhood of datapoints to explain one or more predictions of the machine learning model.

20. The computer program product according to claim 16, wherein the utilizing of the leaves of the multilevel explanation tree representing the neighborhood of datapoints to explain one or more predictions of the machine learning model, and
the computer program product being cloud implemented.
